(19) United States
(12) Patent Application Publication
(10) Pub. No.: US 2019/0138484 A1
(43) Pub. Date: May 9, 2019

(54) CONTROL CIRCUIT

(71) Applicants: Sergio DE SANTIAGO DOMINGUE, Sant Cugat del Valles (ES); Vicente GRANADOS ASENSIO, Sant Cugat del Valle (ES); HEWLETT-PACKARD DEVELOPMENT COMPANY, L.P., Houston, TX (US)

(72) Inventors: Sergio De Santiago Dominguez, Sant Cugat del Valles (ES); Juan Manuel Zamorano, Sant Cugat del Valles (ES); Vicente Granados Asensio, Sant Cugat del Valles (ES)

(73) Assignee: HEWLETT-PACKARD DEVELOPMENT COMPANY, L.P., Houston, TX (US)

(21) Appl. No.: 16/096,033

(22) PCT Filed: Jun. 30, 2016
(86) PCT No.: PCT/EP2016/065292

§ 371 Date: Oct. 24, 2018

(51) Int. Cl. G06F 13/40; B41J 2/175; G06F 1/26; G06F 12/14

(52) U.S. Cl. CPC G06F 13/4081; G06F 12/1408; G06F 1/26; B41J 2/17503

(57) ABSTRACT

A method, control circuit and printing system to control data communications with a plurality of integrated circuits. The method comprises receiving a control signal indicating that a first integrated circuit in the plurality of integrated circuits has been connected to an interface; pausing data communication between a processor and a second integrated circuit in the plurality of circuits over a data bus; and sending an enable signal to transition a switch from an open state to a closed state to connect a power supply to the interface while data communication with the plurality of integrated circuits over the data bus is paused.

### BACKGROUND

Some printing systems utilize one or more removable consumable units, such as printing liquid or printing agent reservoirs for use in 2D and/or 3D printing systems, or build material reservoirs for use in 3D printing systems. A removable consumable unit may include an integrated circuit comprising an internal memory to store data associated with the removable consumable and its usage. This stored data may be readable by a printer to ensure that the consumable unit is used in an intended manner.

### DRAWINGS

Various features and advantages of the present disclosure will be apparent from the detailed description which follows, taken in conjunction with the accompanying drawings, which together illustrate, by way of example only, features of the present disclosure, and wherein:

FIG. 1 is a schematic diagram showing an example of a printing system comprising a printer and a plurality of consumable units.

FIG. 2 is a schematic diagram showing an example of a control circuit for a printer.

FIG. 3 is a schematic diagram showing an example of a control circuit for a printer.

FIG. 4 is a schematic diagram showing an example of a printing system comprising a printer and a plurality of consumable units.

FIG. 5 is a flow diagram showing an example of a method of controlling an integrated circuit.

### DESCRIPTION

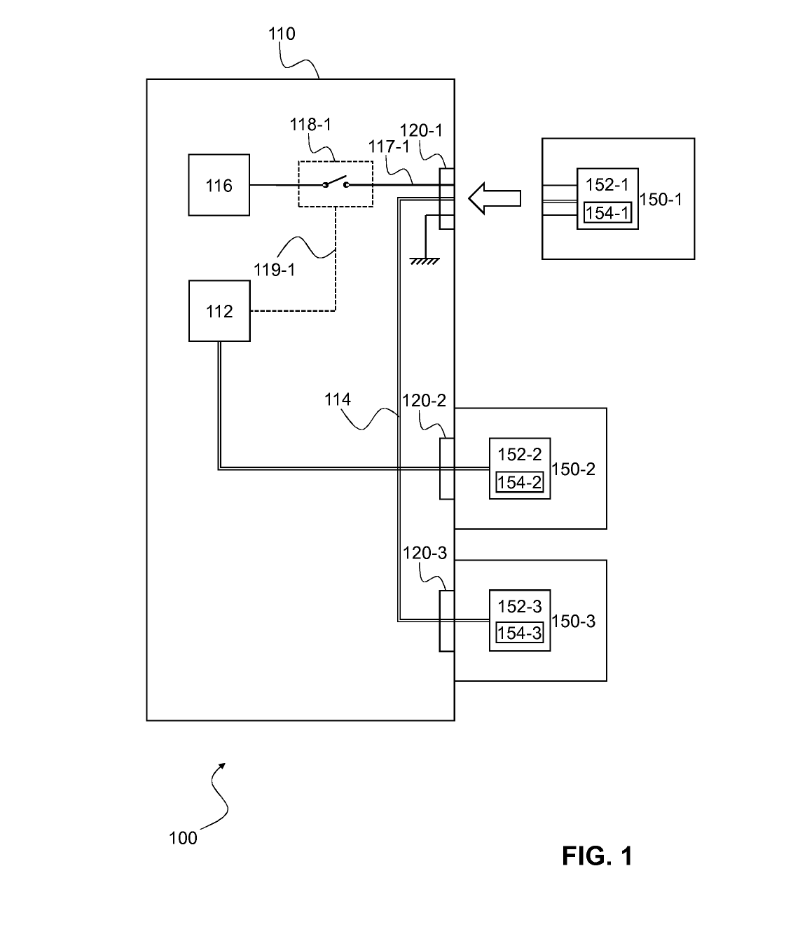

FIG. 1 is a schematic diagram showing an example of a printing system 100 comprising a printer 110 and a plurality consumable units 150-N, where N is a numeral which refers to the particular consumable unit. Each consumable unit 150-N comprises an integrated circuit 152-N, which in turn comprises a memory device 154-N for storing data associated with the respective consumable unit 150-N. In some examples the data stored in the memory device 154-N may be stored in an encrypted format and/or utilize a secure interface to prevent access to the data from unauthorized parties.

At least one of the plurality of consumable units 150-N may be removably connectable to the printer 110, to enable convenient replacement in the event that the consumable is exhausted or is desired to be changed. In the particular example shown in FIG. 1, a first consumable unit 150-1 is removably connectable to the printer 110 and is shown in an initially disconnected position, whereas a second consumable unit 150-2 and a third consumable unit 150-3 are shown in initially connected positions. The printer 110 is provided with a plurality of interfaces 120-N which facilitate power and data connectivity between the printer 110 and the respective consumable units 150-N. In further examples, the functionality provided by the interfaces 120-N may be provided by a plurality of separate interfaces which respectively provide power and data connectivity between the printer 110 and the consumable units 150-N.

The printer 110 comprises a processor 112 which communicates with the integrated circuits 152-N of the consumable units 150-N over a data bus 114 (shown as a double compound solid line in FIG. 1). For example, the processor 112 may communicate periodically with the plurality of integrated circuits 152-N to store and update data relating to usage of the consumable units 150-N in their respective memory devices 154-N. In some examples, the data bus 114 may be a serial data bus which is implemented according to the I²C™ (Inter-Integrated Circuit) specification, as originally developed by Philips Semiconductors™ and presently maintained by NXP Semiconductors™. In this context, the processor 112 of FIG. 1 functions as a “master” device and each of the integrated circuits 152-N function as “slave” devices.

The printer 110 comprises a power supply 116 which provides power to the first consumable unit 150-1 over a power line 117-1 (shown as a single compound solid line in FIG. 1) and interface 120-1. The power supplied to the first consumable unit is used to power the respective integrated circuit 152-1 and memory device 154-1, in addition to any other power consuming functionality provided by the first consumable unit 150-1. According to some examples, the power supply may also provide power to the second consumable unit 150-2 and third consumable unit 150-3 (not shown in FIG. 1).

Control of the power supply to the first consumable unit 150-1 is provided by a control circuit 118-1, shown schematically as a switch in FIG. 1, which is configured to control power supply to the first consumable unit 150-1 under the control of the processor 112. In particular, the control circuit 118-1 is configured to operate the first consumable unit 150-1 according to two states: a “powered state” wherein the power supply is connected to the interface 120-1 (and thus the first consumable unit 150-1), and an “isolated state” wherein the power supply is disconnected or isolated from the interface 120-1 (and thus the first consumable unit 150-1). The processor 112 is configured to control the control circuit 118-1 to switch between the powered state and the isolated state by means of a control line 119-1 (shown as a single compound dashed line in FIG. 1) between the processor 112 and the control circuit 118-1.

In some examples, the data bus 114 may be sensitive to noise induced by voltage changes in the power line 117-1 associated with the first consumable unit 150-1. For example, voltage changes in the power line 117-1 may be caused by connection and disconnection of the first consumable unit 150-1 to its respective interface 120-1. This induced noise on the data bus 114 has the potential to generate one or more spurious data values, which may in turn affect the correct operation of the integrated circuits 152-2 & 152-3 associated with the second and third consumable units 150-2 & 150-3. For example, the one or more spurious data values induced on the data bus 114 may be detected by one or both of the integrated circuits 152-2 & 152-3 as a malicious attempt to circumvent the encryption employed to secure data stored in the respective memory devices 154-2 & 154-3. As a result of this detection, the integrated circuits 152-2 & 152-3 may initiate one or more countermeasures to prevent unauthorized access, such as activating a locking mechanism to prevent further access to data stored in the respective memory devices 154-2 & 154-3. In some cases, these countermeasures may prevent further use of the consumable units 150-2 & 150-3, thereby causing inconvenience and additional expense for users of the printing system 100.

In order to reduce the instances of spurious data values being induced on the data bus 114, the processor 112 is configured to maintain the control circuit 118-1 associated with the first consumable unit 150-1 in the isolated state, such that the interface 120-1 is isolated from the power supply 116 upon connection or insertion of the first consumable unit 150-1. Upon detection of insertion or connection of the first consumable unit 150-1, the processor 112 pauses or stops data communication over the data bus 114 (i.e. data communication with the second and third integrated circuits 152-2 & 152-3), before switching the control circuit to the “powered state” to provide power to the interface 120-1 and the first consumable unit 150-1. After switching the control circuit 118-1 to the powered state, the processor 112 resumes data communication over the data bus (i.e. data communication with the first, second and third consumable units 150-1 to 150-3). In this manner, incidents of spurious data values being induced on the data bus 114 due to insertion or connection of the first consumable unit 150-1 can be reduced or eliminated.

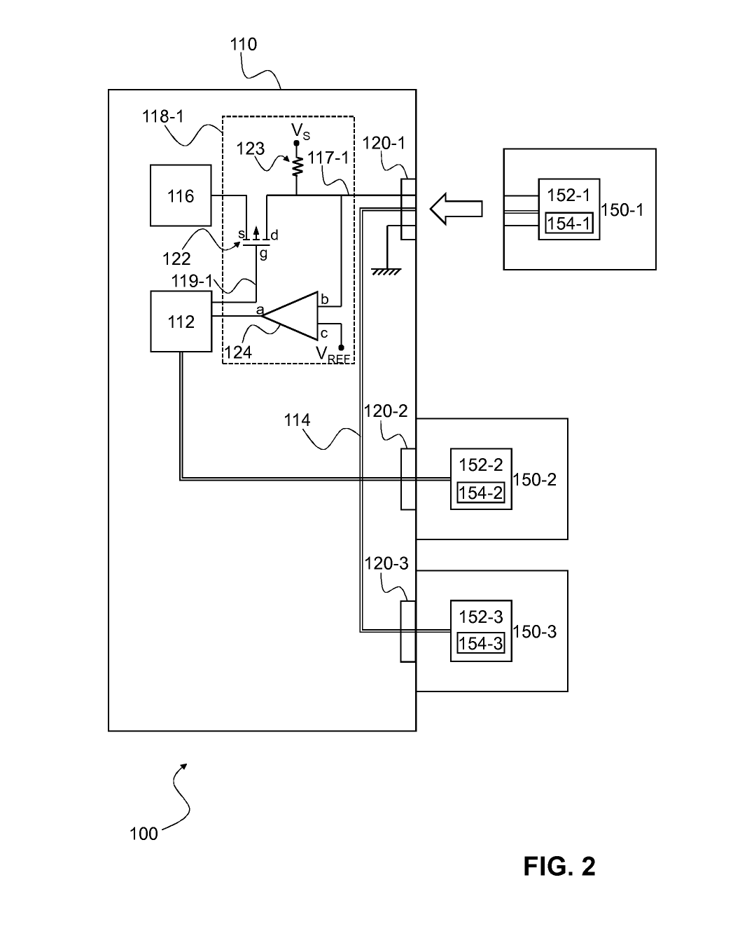

FIG. 2 is a schematic diagram showing an example of the control circuit 118-1 for use in the printer 110 of FIG. 1. In this example, the control circuit 118-1 comprises a switch 122-1 located between the power supply 116 and the power line 117-1 to the interface 120-1 associated with the first consumable unit 150-1. The switch 122-1 comprises an open configuration in which the power supply 116 is disconnected from the interface 120-1 (i.e. providing the “isolated state” discussed above) and a closed configuration in which the power supply 116 is connected to the interface 120-1 (i.e. providing the “powered state” discussed above). The switch 122-1 may operate in the open configuration by default and transition to the closed state in response to an enable signal received on the control line 119-1 from the processor 112. Thus, in the absence of the enable signal, the switch 122-1 remains in the open configuration and the interface 120-1 remains isolated from the power supply 116.

In the particular example shown in FIG. 2, the switch 122-1 is a field effect transistor (FET), such as a p-channel metal-oxide-semiconductor field effect transistor (MOSFET), comprising a source terminal “s”, a drain terminal “d” and a gate terminal “g”. An example of a suitable MOSFET for use in the control circuit 118-1 is the IRLM5202 HEXFET™ Power MOSFET manufactured by International Rectifier™ of El Segundo, Calif., United States of America. In this example, the power supply 116 is be connected to the source terminal of the FET, the power line 117-1 to the interface 120-1 is connected to the drain terminal of the FET and the control line 119-1 from the processor is connected to the gate terminal of the FET. In further examples, the switch may be a bipolar junction transistor (BJT).

The control circuit 118-1 of FIG. 2 comprises a pull-up transistor 122 which is connected to the power line 117-1 to bias the voltage at the interface 120-1 to a first voltage Vₛ when the switch 122-1 is in the open configuration (i.e. the power supply 116 is isolated from the interface 120-1) and the integrated circuit 152-1 of the consumable unit 150-1 is disconnected from the interface 120-1. For example, the first voltage Vₛ may be set to 5V and asserted through a pull-up resistor 123 with a resistance of 1 MΩ.

The control circuit 118-1 further comprises a comparator 124, such as a voltage comparator, to detect a voltage drop at the interface 120-1 from the first voltage Vₛ to a second voltage V_{REF} , caused by connection of the first the consumable unit 150 to the interface 120-1. This voltage drop is caused by the current drawn down by the integrated circuit 152-1 of the first consumable unit 150-1, through the pull-up resistor 123 of the control circuit 118-1. The voltage comparator 124 comprises a first input “a” connected to the powerline 117-1 (and thus indirectly to the interface 120-1) and a second input “b” connected to a voltage source with voltage V_{REF}. The second voltage V_{REF} serves as a threshold voltage, indicative of the integrated circuit 152-1 of the first consumable unit 150-1 being connected to the interface 120-1. In examples where the first voltage (i.e. the bias voltage) is set at 5 V, the second voltage (i.e. the reference voltage) may be set to approximately 3.5 V. An example of a suitable voltage comparator for use in the control circuit 118-1 is the LMC6762 Dual MicroPower Rail-To-Rail Input CMOS Comparator manufactured by Texas Instruments™ of Dallas, Tex., United States of America.

The voltage comparator 124 further includes an output “c” which is connected to the processor 112 as an input. In response to detecting a drop in voltage at the interface from the first voltage Vₛ to the second voltage V_{REF} (or below), the voltage comparator 124 outputs a control signal to the processor 112. The processor 112 interprets the control signal as an indicator that the first consumable unit 150-1 has been connected to the interface 120-1 of the printer 110 and proceeds to pause or stop data communication with any integrated circuits 152-N which are connected to the data bus 114 (i.e. the integrated circuits 152-2 & 152-3 associated with the second and third consumable units 150-2 & 150-3 respectively). After pausing or stopping data communication, the processor 112 sends send an enable signal to the switch 122 on control line 119-1 to transition the switch 122 from the open state to the closed state, thereby connecting the power supply 116 to the interface 120-1 and the integrated circuit 152-1 associated with the first consumable unit 150-1. In this respect, it will be noted that transition of the first consumable unit 150-1 from the isolated state to the powered state occurs while data communications over the data bus 114 are paused, thereby reducing the likelihood of spurious data values being induced on the data bus 114 during this connection process. In turn, this ensures that the integrated circuits 152-2 & 152-3 do not initiate countermeasures which may result in the locking or disabling of data stored in the associated memory devices 154-2 & 154-3.

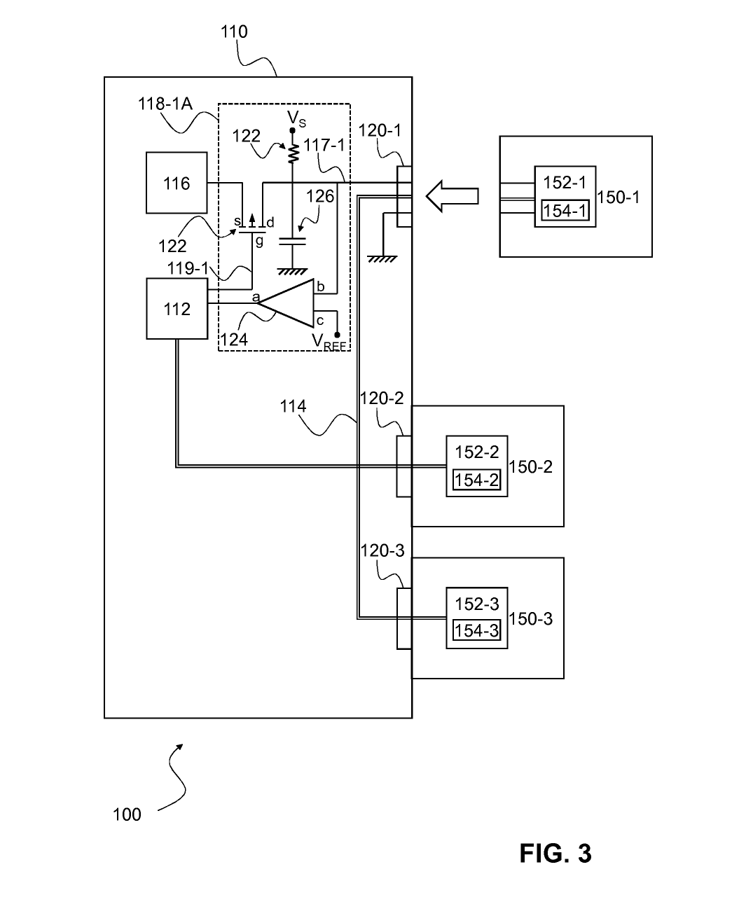

FIG. 3 is a schematic diagram showing a further example of a control circuit 118-1A for use in the printer 110 of FIG. 1. In this example, the control circuit 118-1A is substantively the same as that shown in FIG. 2 and the same reference numerals have been used to denote common components. In this example, the interface 120-1 associated with the first consumable unit 150-1 is connected to ground through a capacitor 126 which functions as a decoupling capacitor to filter out relatively high frequency noise on the control circuit 118. For example, the interface 120-1 may be connected to ground through a decoupling capacitor 126 with a capacitance in the range 1 to 110 nF. In one example a capacitance of approximately 10 nF may be chosen.

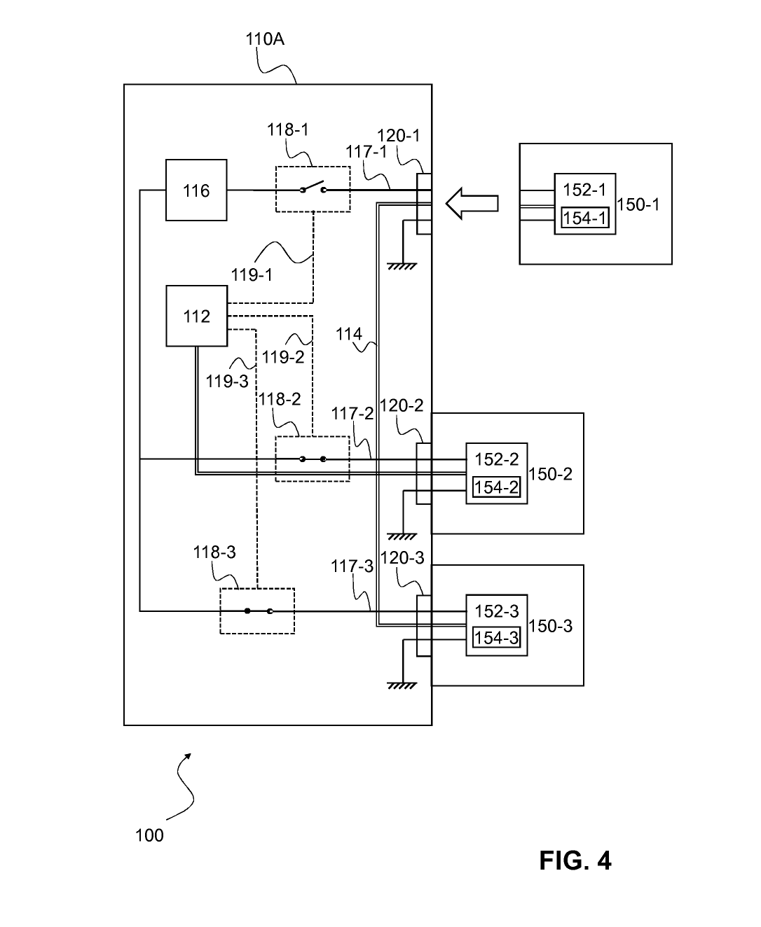

In further examples, the processor 112 may be configured to temporarily isolate (i.e. disconnect) the power supply 116 from the second consumable unit 150-2 and the third consumable unit 150-3 in response to detecting insertion of the first consumable unit 150-1, in addition to pausing data communications on the data bus 114. FIG. 4 shown an example of a printer 110A configured in this matter, including additional second and third control circuits 118-2 & 118-3 corresponding respectively to the second and third consumable units 150-2 & 150-3. In this example, the second and third control circuits 118-2 & 118-3 are located between the power supply and power lines 117-2 & 117-3 to the respective interfaces 120-2 & 120-3. The second and third control circuits 118-2 & 118-3 are controlled by the processor 112 via an enable signal transmitted over respective control lines 119-2 & 119-3. In the configuration shown in FIG. 4, the first consumable unit 150-1 is disconnected from the printer 110A, the first interface 120-1 is isolated from the power supply 116 by first control circuit 118-1, and the second and third interfaces 120-2 & 120-3 are connected to the power supply by second and third control circuits 118-2 & 118-3. In response to detecting insertion of the first consumable unit 150-1 (and thus the first integrated circuit 152-1), the processor 112 pauses data communication on the data bus 114 and controls the second and third control circuits 118-2 & 118-3 to transition the second and third consumable units 150-2 & 150-3 to the isolated state. Once this transition has completed, the processor 112 controls the first, second and third control circuits 118-1 to 118-3 to transition each to the respective consumable units 150-1 to 150-3 to the powered state and resumes data communications on the data bus 114. By isolating the second and third consumable units 150-2 & 150-3 from the power supply 116 in this manner, the processor 112 can further reduce the possibility that the second and third integrated circuits 152-2 & 152-3 respond to the insertion event by initiating countermeasures, such as locking their respective memory devices 154-2 & 154-3.

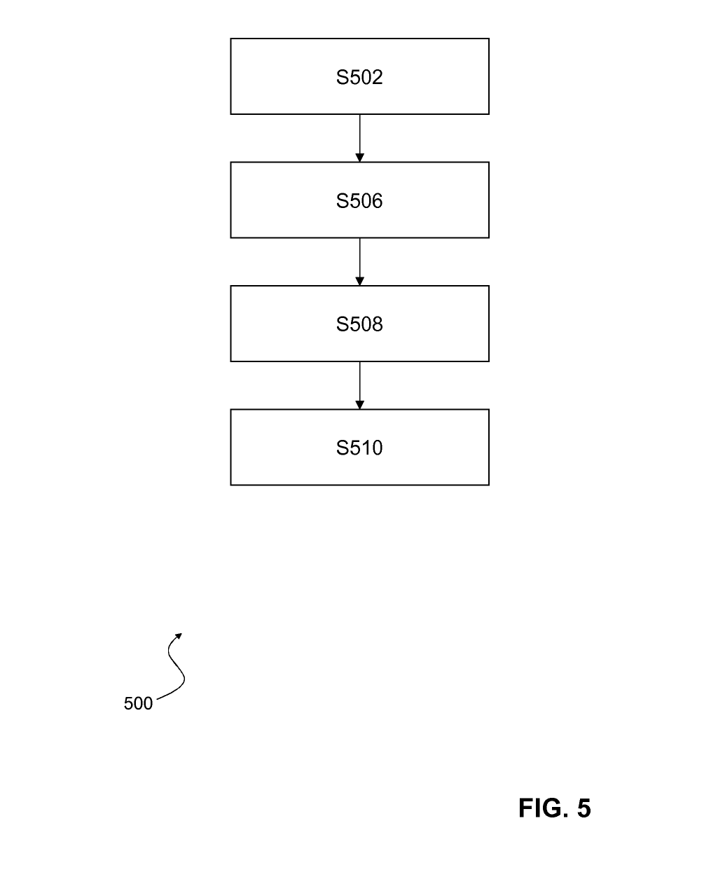

FIG. 5 is a flow chart showing an example of a method 500 performed by the processor 112 to control the plurality of integrated circuits 152-N as shown in FIGS. 1 to 4. First, the processor 112 detects the control signal (e.g. received from the voltage comparator 124) indicating that the integrated circuit 152-1 has been connected to the interface (S502). After receiving the control signal, the processor 112 pauses or stops data communications over the data bus 114 and/or isolates the power supply 116 from integrated circuits 152-2 and 152-3 (S504). Next, the processor 112 sends or asserts an enable signal to the control circuit 118-1, 118-1A to transition the first consumable unit 150-1 from the isolated state to the connected state by connecting the power supply 116 to the interface 120-1 and the first integrated circuit 152-1 (S506). After the first consumable unit 150-1 has transitioned to the connected state, the processor 112 resumes or restarts data communications over the data bus 114 with each of the connected integrated circuits 152-N and reconnects the power supply 116 to integrated circuits 152-2 and 152-3 (S508).

In some examples, one of more of the integrated circuits 152-N may be an application-specific integrated circuit (ASIC) or a field-programmable gate array (FPGA). Further one of more of the memory devices 154-N associated with the integrated circuits 152-N may comprise volatile memory, non-volatile memory or a combination of both. For example, at least one of the memory devices 154-N may comprise solid state flash memory for storage of data associated with the consumable unit.

In the examples described above with reference to FIGS. 1 to 5, the second consumable unit 150-2 and the third consumable unit 150-3 are shown as connected to the printer 110. However, it will be appreciated that the second consumable unit 150-2 and/or third consumable unit 150-3 may also be removably connectable to the printer 110 in the same manner as the first consumable unit 150-1. Indeed, the printer system 100 may comprise any number of consumable units 150-N, one or more of which may be removal connectable to the printer 110. In this respect, a separate control circuit 118-N and interface 120-N may be provided for each removably connectable consumable unit 150-N, such that the processor can detect insertion or connection for each interface 120-N and control data communications to the associated integrated circuits in the manner described above with reference to FIG. 4.

In further examples, the interface 120-1 associated with the first consumable unit may be located remote from the printer 110 and connected to the printer 110 by a cable or other appropriate means to provide power and data communications to the interface 120. Such arrangement may, for example, be employed where the associated consumable unit 150-1 is particularly bulky, as may be the case with a 3D printing system.

In some examples, the data stored in the memory device 154-N associated with each integrated circuit 152-N may include usage data, identification data, calibration data, printing parameters, manufacturing information, servicing information, and other information pertinent to the associated consumable unit. In some examples, the data may be encrypted by the processor 112 prior to storage on the memory devices 154 using, for example, a symmetric encryption algorithm.

In some examples, the consumable unit may comprise a reservoir to store printing liquid or printing agent for 2D or 3D printing systems. In other examples, the consumable unit may comprises build material (e.g. a powder, paste, slurry or liquid material) for using in a 3D printing system.

Further, it will be appreciated that in some examples one or more of the integrated circuits 152-N need not be associated with a consumable unit. For example, one of more of the integrated circuits 152-N may be embedded in the printer 110 itself, or an external peripheral device which is removably connectable to the printer 110.

Certain system components and methods described herein may be implemented by way of computer program code that is storable on a non-transitory storage medium. The computer program code may be implemented by a control system comprising at least one processor that is arranged to retrieve data from a computer-readable storage medium. The control system may comprise part of an object production system such as an additive manufacturing system. The computer-readable storage medium may comprise a set of computer-readable instructions stored thereon. The at least one processor may be configured to load the instructions into memory for processing. The instructions are arranged to cause the at least one processor to perform a series of actions. The instructions may instruct the method 300 of FIG. 3 and/or any other of the methods or processes described hereinbefore. The non-transitory storage medium can be any media that can contain, store, or maintain programs and data for use by or in connection with an instruction execution system. Machine-readable media can comprise any one of many physical media such as, for example, electronic, magnetic, optical, electromagnetic, or semiconductor media. More specific examples of suitable machine-readable media include, but are not limited to, a hard drive, a random access memory (RAM), a read-only memory (ROM), an erasable programmable read-only memory, or a portable disc. The preceding description has been presented to illustrate and describe examples of the principles described.

This description is not intended to be exhaustive or to limit these principles to any precise form disclosed. Many modifications and variations are possible in light of the above teaching.

What is claimed is:

1. A control circuit to control data communications with a plurality of integrated circuits, the control circuit comprising:
a processor to communicate with a plurality of integrated circuits over a data bus;
an interface connectable to an integrated circuit in the plurality of integrated circuits;
a first circuit portion comprising a switch to connect a power supply to the interface in response to an enable signal and to disconnect the power supply from the interface in the absence of the enable signal;
a second circuit portion to bias the voltage at the interface at a first voltage level when the power supply is disconnected from the interface and the interface is disconnected from the integrated circuit; and
a comparator to output a control signal when the voltage at the interface changes to a second voltage level in response to a connection between the interface and the integrated circuit when the power supply is disconnected from the interface;
wherein the processor is configured to:
pause data communication over the data bus in response to the control signal.

2. The control circuit of claim 1, wherein the processor is configured to:
provide the enable signal to the switch to connect the power supply to the interface while data communication with the plurality of integrated circuits over the data bus is paused; and
resume data communication with the plurality of integrated circuits over the data bus after the power supply has been connected to the interface.

3. The control circuit of claim 1, wherein the second circuit portion comprises a pull-up resistor to bias the voltage at the interface at the first voltage level when the power supply is disconnected from the interface and the interface is disconnected from the integrated circuit.

4. The control circuit of claim 1, wherein the first voltage level is a logically high level and the second voltage level is a logically low level, lower than the logically high level.

5. The control circuit of claim 1, further comprising a decoupling capacitor between the interface and ground to filter noise from the power supply.

6. The control circuit of claim 1, wherein the switch comprises a transistor.

7. The control circuit of claim 6, wherein the transistor is a metal-oxide-semiconductor field-effect transistor.

8. The control circuit of claim 1, wherein the data bus is a serial data bus.

9. A printing system comprising:
a processor;
a power supply;
an interface for removably coupling at least one integrated circuit to the printing system; and
interface circuitry to control said coupling, the interface circuitry comprising:
a switch to connect the power supply to the interface in response to an enable signal;
a resistor to bias a voltage at the interface when the power supply is disconnected and the interface is disconnected from the integrated circuit;
a comparator to compare the voltage at the interface with a reference voltage,
wherein a control signal output by the comparator changes in response to a connection between the interface and the integrated circuit when the power supply is disconnected from the interface, and
wherein the processor is configured to pause data communication via the interface in response to the control signal.

10. The printing system of claim 9, wherein the at least one integrated circuit forms part of a removable consumable unit.

11. The printing system of claim 10, wherein the consumable unit comprises a printer fluid reservoir or a build material reservoir.

12. The printing system of claim 9, comprising:
a two or three dimensional printer.

13. A method of controlling data communications with a plurality of integrated circuits, the method comprising:
receiving a control signal indicating that a first integrated circuit in the plurality of integrated circuits has been connected to an interface;
pausing data communication between a processor and a second integrated circuit in the plurality of circuits over a data bus; and
sending an enable signal to transition a switch from a first state to a second state to connect a power supply to the interface while data communication with the plurality of integrated circuits over the data bus is paused.

14. The method of claim 13, further comprising:
resuming data communication with the plurality of integrated circuits over the data bus after the power supply has been connected to the interface.

15. The method of claim 13, wherein the control signal is indicative of a change in voltage at the interface from a first voltage level to a second voltage, the second voltage level being lower than the first voltage level.
